(19) United States
(12) Patent Application Publication
(10) Pub. No.: US 2006/0220895 A1
(43) Pub. Date: Oct. 5, 2006

(54) Ambient light sensing solar powered pulsed LED visual indicator apparatus and method

(75) Inventors: Angelo S. Arcaria, Colchester, CT (US); Raymond LeBlanc, Bristol, CT (US); Kenneth R. Taylor, Ivoryton, CT (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Edwards Systems Technology, Inc.

(21) Appl. No.: 11/082,880

(22) Filed: Mar. 18, 2005

(51) Int. Cl. G08B 5/00

(52) U.S. Cl. 340/815.4; 340/300

(57) ABSTRACT

A visual indicator includes a solar panel, a rechargeable battery operatively connected to the solar panel for charging the rechargeable battery with power from the solar panel, a light emitting diode (LED) operatively connected to the rechargeable battery to emit light, and a controller operatively connected to the rechargeable battery and the LED to control operating characteristics of the LED. A method of operating a visual sensor includes recharging a battery from a solar panel, emitting light with a light emitting diode (LED) from power provided by the battery, sensing ambient light conditions proximate to the visual sensor, varying an intensity of light emitted from the LED based on the sensed ambient light conditions.

### FIELD OF THE INVENTION

The present invention relates generally to signaling devices. More particularly, the present invention relates to a solar-powered, light-emitting signaling device.

### BACKGROUND OF THE INVENTION

Visual indicators, such as lights, have long been used for calling attention to particular items. For example, exit doors and emergency callboxes, such as those located along highways, for assisting stranded motorists, or found on college campuses, or in other areas which have often been lit by light-emitting visual indicator devices. Often the light-emitting device is in a constantly on position displaying a steady light which may be, for example, blue, red, yellow, green or any desired color to indicate the location of an emergency callbox.

Light-emitting devices require power in order to emit a steady stream of light. Because emergency callboxes may not be located near power lines or other power sources providing power to the visual, light-emitting indicator can be problematic.

Further, often the visual light-emitting indicators switch modes when an actuator associated with the indicator has been actuated. For example, if a call is made on a callbox, the steady locator light can change to flashing.

Studies of light signaling devices used in industrial, commercial and institutional areas indicate that effective warning is accomplished by signaling devices that combine a bright strobe-like, rapid flickering or pulsing visual light signal with high color intensity. Pulsing colored lights are highly desirable in light signaling devices because pulsing colors, particularly blue, have become associated with an emergency indication in a variety of applications. Thus, a device is particularly needed in applications where constantly lit, high visible light is desired to indicate the presence of an emergency callbox or other device for which its location is desired to be indicated. A device is needed that is suitable to be located in a remote areas and not necessarily require external power to be brought to the device. Further, it is desirable to provide a method and apparatus that can change from a steady light-emitting situation to a strobe or flashing condition when an actuator has been actuated.

### SUMMARY OF THE INVENTION

The foregoing needs are met, to a great extent, by the present invention, wherein in one aspect an apparatus is provided that in some embodiments provide a light-emitting visual indicator that does not require external sources of power and is capable of providing a steady light emission to indicate its location and change from a steady light emission to a strobe or flashing light-emitting status when an actuator associated with the visual indicator has been actuated.

In accordance with one embodiment of the present invention, a visual indicator is provided. The visual indicator includes a solar panel, a rechargeable battery operatively connected to the solar panel for charging the rechargeable battery with power from the solar panel, a light emitting diode (LED) operatively connected to the rechargeable battery to emit light, and a controller operatively connected to the rechargeable battery and the LED to control operating characteristics of the LED.

In accordance with another embodiment of the present invention, a visual indicator is provided. The visual indicator provides means for obtaining energy from sunlight, means for storing energy operatively connected to the means for obtaining energy for charging the means for storing energy, means for emitting light to the means for storing energy, means for controlling the visual indicator operatively connected to the means for storing energy and the light emitting means to control operating characteristics of the means for storing light.

In accordance with yet another embodiment of the present invention, a method of operating a visual sensor is accomplished. The method includes recharging a battery from a solar panel, emitting light with a light emitting diode (LED) from power provided by the battery, sensing ambient light conditions proximate to the visual sensor, varying an intensity of light emitted from the LED based on the sensed ambient light conditions.

In accordance with yet another embodiment of the present invention, a visual indicator is provided. The visual indicator includes a light emitting diode (LED) operatively connected to a power source to emit light; a controller operatively connected to the power source and the LED to control operating characteristics of the LED, wherein the controller is configured to operate the LED to vary in at least one of the following operating characteristics: brightness, intensity, to flash, turn on, and turn off; and a photo sensor operatively connected to the controller to send a signal to the controller associated to an amount of ambient light sensed by the sensor, wherein the controller alters at least one operating characteristic of the LED in response to the signal received by the sensor.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view illustrating an emergency callbox with a light-emitting visual indicator mounted on top of it, in accordance with an exemplary embodiment of the invention.

FIG. 2 is a front view of a light-emitting visual indicator, in accordance with one embodiment of the invention.

FIG. 3 is a schematic diagram illustrating how different components of the light-emitting visual indicator can be connected to each other according to an embodiment of the invention.

### DETAILED DESCRIPTION

The invention will now be described with reference to the drawing figures, in which like reference numerals refer to like parts throughout. An embodiment in accordance with the present invention provides a solar-powered, light-emitting visual indicator. The solar-powered, light-emitting visual indicator includes a rechargeable battery for providing power to the indicator during periods of darkness.

In some embodiments of the invention, an actuator is provided such as an actuator like a telephone associated with a callbox, along with the visual indicator for when an emergency situation arises. The visual indicator will transform from a steady light-emitting state to a strobe or flashing light emission when the actuator has been actuated. In some embodiments of the invention, the light-emitting visual indicator is associated with a telephone for providing communication between the person signaling the emergency and a system monitoring the callbox or emergency services. In other embodiments of the invention, the callbox, including the light-emitting visual indicator can also be connected to a monitoring system that can monitor when an actuator associated with the visual indicator has been actuated.

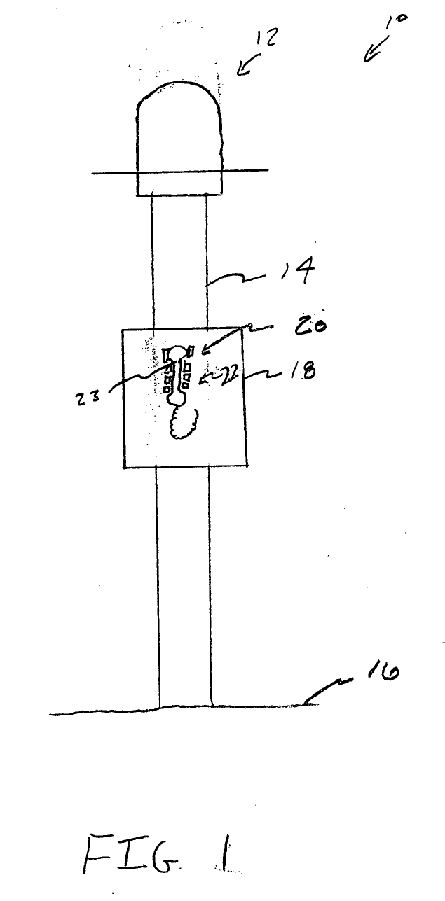

An embodiment of the present inventive apparatus is illustrated in FIG. 1. As shown in FIG. 1, the emergency callbox 10 includes a visual indicator 12 mounted on top of a support pole 14, which is placed in an upright manner into the ground 16. The pole 14, in some embodiments, may not extend into the ground but may be mounted to a base sitting on the ground 16. Mounted also to the pole 14 is the box 18 containing a telephone 20 with actuators or buttons 22 which allow the user to place a call or press actuators 22. In some embodiments, actuating different actuators may indicate different situations are being reported from the callbox 12. In some embodiments of the invention, no call would need to be placed, but rather the mere act of picking up the handset 23 will connect the user with emergency services personnel or system monitors. In other embodiments of the invention, calls will be placed by dialing, using the actuators 22 in a conventional manner.

According to some embodiments of the invention, once a call has been placed with a telephone 20, the visual indicator 12 will change from a steady light-emitting state to emitting light in a flashing manner. According to some embodiments of the invention, the visual indicator 12 can emit light in several different manners. It may have different operating characteristics which include emitting or changing the brightness of the light, the intensity, flashing the light, turning the light on or off, or changing the colors of the light, according to the specific needs and requirements of a particular installation.

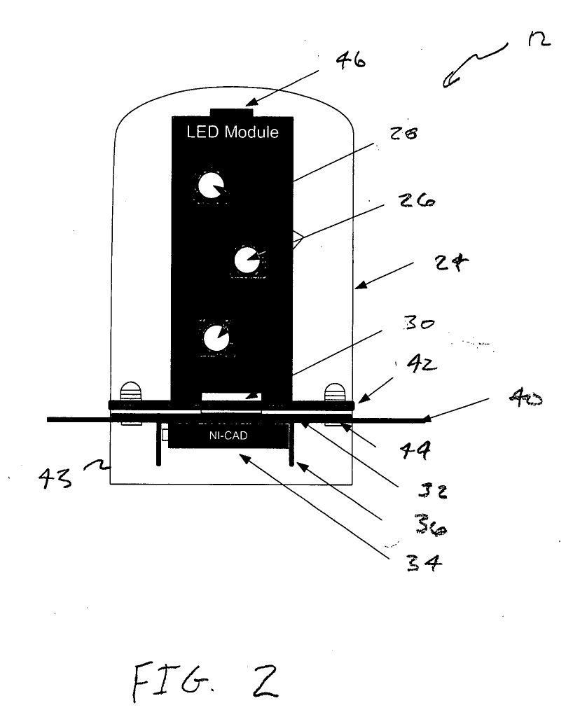

Turning now to FIG. 2, a detailed front view of a visual indicator 12 is illustrated. According to some embodiments of the present invention, the visual indicator 12 has a housing 24 which may also be a lens 24. In some embodiments of the present invention, the lens 24 may be transparent or in other embodiments merely translucent. Further, the lens 24 may also be a multiple fresnel lens 24. The lens or housing 24 can also protect the interior components of the visual indicator 12 from damage or corrosion caused by weather or other foreign objects entering the visual indicator 12.

According to some embodiments of the present invention, the light is provided by light-emitting diodes (LEDs) 26. The light-emitting diodes 26 may be mounted in a vertically-oriented circuit board 28. The vertically-oriented circuit board 28 may be connected to a mounting connector 30 which connects the vertically-oriented circuit board 28 to a printed circuit board 32 laying in a horizontal manner.

Connected to the light-emitting diodes 26 via the circuit boards 28 and 32, is a rechargeable battery 34. In some embodiments of the invention, the rechargeable battery 34 is a nickel caladium battery (NI-CAD) battery. In other embodiments of the invention, the rechargeable battery 34 may be lithium ion battery or any other suitable rechargeable-type battery. The rechargeable battery 34 is contained within a battery housing 36.

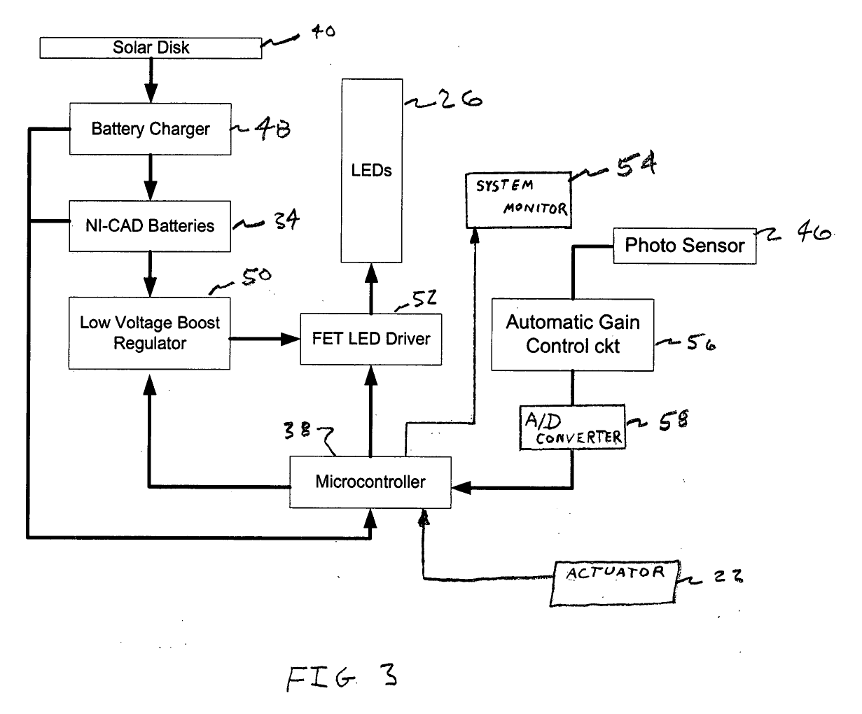

A controller 38 (not shown in FIG. 2, but shown in FIG. 3) controls the connection occurring between the rechargeable battery 34 and the LEDs 26. Thus, the controller 38 controls the LEDs 26 whether they are on or off, flashing or steady, bright or dim, or which LED 26 will illuminate to provide the desired color.

A solar panel 40 is also mounted on the visual indicator 12 and oriented so that during daylight hours, the solar disk 40 can capture sunlight and convert it to energy used to recharge the rechargeable battery 34. In some embodiments of the invention, the solar panel 40 is in a disk shape.

A gasket 42 is used to connect the housing 24 with the lower part 43 of the visual indicator 12. The gasket 42 may be of any suitable material to accomplish the goal creating a seal to protect the interior parts of the visual indicator 12.

Mounting screws 44 may be located appropriately in the visual indicator 12 to attach the housing 24 to the lower portion 43 of the visual indicator 12, which includes the rechargeable battery 34 to the battery housing 36, and the solar panel 40.

In some embodiments of the present invention, a photo sensor 46 is mounted within the visual indicator 12 in a location to appropriately sense ambient light conditions associated with the visual indicator 12. In order to save battery life, the LED 26 lights may be dimmed when ambient light conditions are low and less light is required to be emitted from the LEDs in order for the visual indicator 12 to be seen. Conversely, in high ambient light conditions, for example, noon day, the LEDs can emit greater amounts of light in order for the visual indicator 12 to be seen. According to some embodiments of the invention, the photo sensor 46 may be operatively connected to the controller 38 (seen in FIG. 3) to provide a signal to the controller 38 regarding ambient light conditions. The controller 38 then controls the LEDs 26 in view of the signal received from the photo sensor 46.

FIG. 3 illustrates a schematic of how different components of the visual indicator 12 are connected and communicate with each other. The solar disk 40 is operatively connected to a battery charger 48. The battery charger is, in turn, operatively connected to the rechargeable batteries 34. Both the battery charger 48 and the rechargeable battery 34 (or in some embodiments of the invention, batteries 34) are connected to the controller 38. In some embodiments of the invention, the controller 38 is a microcontroller, which can be programmed according to a specific user needs. A microcontroller 38 can monitor the state of the rechargeable battery 34 and increase, decrease or turn off the amount of charging the battery charger 34 applies to the rechargeable batteries 34.

The LEDs 26 receive power from the batteries 34. According to some embodiments of the invention, the batteries 34 are operatively connected to a low-voltage boost regulator 50, which is operatively connected to a field-effect transistor (FET) LED driver 52. The low-voltage boost regulator 50 can boost the amount of voltage applied to the LED 26 from the battery 34 according to the voltage requirements of the LED 26. The low-voltage boost regulator 50 is also connected to the microcontroller 38 so that the microcontroller 38 can control the voltage output of the low voltage boost regulator 50.

LEDs 26 are rated for a certain amount of normal current that can be applied to the LEDs 26 without burning out the LED 26. However, many LEDs 26 can withstand, for a short burst, significant amount of current above the rated level. In situations where the LED 26 is desired to flash, the LED 26 can be supplied power much greater than its rated level as long as the power is pulsed and not supplied to the LED 26 in a steady state. In situations where it is desirable for the visual indicator 12 to flash, the LEDs 26 may be pulsed with current higher than their nominally-rated amount. The pulsing function can be accomplished by the FET LED driver 52.

The FET LED driver 52 is operatively connected to the LEDs 26 and the low-voltage boost regulator 50. The FET LED driver 52 is operatively connected to the microcontroller 38. The microcontroller 38 will control the FET LED driver 52 to provide either a steady current to the LEDs 26 to provide steady light emission from the LEDs 26 or to provide pulses of a light to the LEDs 26.

An actuator 22 (which may be in the form of buttons or lifting the handset 23 off of the telephone receiver) is connected to the microcontroller 38. Once a signal from the actuator 22 is received from the microcontroller 38, the microcontroller 38 will then transmit a signal to the FET LED driver 52 to change the operating characteristics of the LEDs 26. As mentioned above the operating characteristics may include but are not limited to the LEDs 26 being on or off, bright or dim, steady or flashing, or even change the color of light emitted, according to the individual requirements of an individual installation.

In some embodiments of the present invention, the callbox 10 is a part of a larger system of several callboxes that are monitored by a system monitor 54. The controller 38 may be operatively connected to a system monitor 54 so that the system monitor 54 will receive a signal from the controller 38 indicating that there is a problem at the location of the callbox 10. In some embodiments of the invention, the microcontroller 38 will send a signal to the system monitor 54 whenever the actuator 22 has been actuated. In some embodiments of the present invention, the actuator 22 can provide a variety of different signals to the microcontroller 38, which then, in turn, provides a variety of signals to the system monitor 54 to indicate what type of problem a user is reporting to the system monitor 54.

In some embodiments of the present invention, a photo sensor 46 is located on the visual indicator 12 in a way to detect ambient light conditions. The photo sensor 46 sends a signal via an automatic gain control circuit 56 which boosts the size or strength of the signal to send it to an analog-to-digital converter 58, which, in turn, converts the analog signal that has been magnified by the automatic gain control circuit 56 but which originated with a photo sensor 46 to a digital signal and input it into the controller 38. The signal received from the photo sensor 46 will indicate how much ambient light is associated with the visual signal indicator 12.

In some embodiments of the invention, the microcontroller 38 will have a look-up table and compare the magnitude of the signal received from the photo sensor 46 to determine what signal to send to the FET LED driver 52 to cause it to control the LED 26 to emit a desired amount of light according to the ambient light conditions.

As previously mentioned, when ambient light conditions are relatively bright, the LEDs 26 will emit more light in order to provide a visual signal. However, when ambient light conditions are low, the LED 26 will emit less light and, thus, save power and not require such a large drain from the battery 34 and still achieve the result of being seen. Thus, in some embodiments of the invention, the amount of light detected by the photo sensor 46 is used to determine how intensely the LED 26 emits light. In some embodiments of the invention, the photo sensor 46 may be constantly sensing ambient light conditions and sending a signal to the controller 38, which is, in turn, constantly adjusting how intensely the LED 26 emits light via what type of signal as sent to the FET LED driver 52. In other embodiments of the invention, the photo sensor 46 senses ambient light conditions only at intervals that may be determined by the system operator. For example, the controller 38 may send a signal to the photo sensor 46 to take a photo reading. In other embodiments of the invention, the photo sensor 46 may send the signals to the controller 38 based on timed intervals.

According to some embodiments of the invention, the greater amount of light sensed by the photo sensor 46 will cause a larger voltage signal to be sent to the automatic gain control circuit 56, which may increase the signal by 2-3 times and then send the increased signal to the analog-to-digital converter 58, which, in turn, sends a digital signal to the controller 38. Lower light conditions will cause the photo sensor 46 emit a smaller or lower voltage signal to the automatic gain control circuit 56. Thus, how much voltage is applied to the microcontroller 38 may directly correspond to how much light has been detected by the photo sensor 46.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A visual indicator comprising:
a solar panel;
a rechargeable battery operatively connected to the solar panel for charging the rechargeable battery with power from the solar panel;
one or more light emitting diode (LEDs) operatively connected to the rechargeable battery to emit light; and
a controller operatively connected to the rechargeable battery and the LED to control operating characteristics of the LED.

2. The visual indicator of claim 1, wherein the controller is configured to operate the LED to vary in at least one of the following operating characteristics: brightness, intensity, to flash, turn on, and turn off or LED color.

3. The visual indicator of claim 2, further comprising a photo sensor operatively connected to the controller to send a signal to the controller associated to an amount of ambient light sensed by the sensor.

4. The visual indicator of claim 3, wherein the controller alters at least one operating characteristic of the LED in response to the signal received by the sensor.

5. The visual indicator of claim 2, further comprising an actuator operatively connected to the controller to send a signal to the controller to vary at least one of the operating characteristics.

6. The visual indicator of claim 5, wherein the actuator includes a telephone.

7. The visual indicator of claim 3, further comprising a gain control circuit located between the sensor and the controller.

8. The visual indicator of claim 3, further comprising an analog to digital converter located between the sensor and the controller for converting the signal from the sensor from an analog signal to a digital signal.

9. The visual indicator of claim 1, further including a translucent housing encompassing at least in part the LED.

10. The visual indicator of claim 9, wherein the housing includes a multiple fresnel lens.

11. The visual indicator of claim 1, wherein the rechargeable battery is a nickel caladium (NI-CAD) battery.

12. The visual indicator of claim 1, wherein the LED is mounted to a circuit board.

13. The visual indicator of claim 1, further comprising a field effect transmitter operatively connected to the LED for controlling current applied to the LED.

14. The visual indicator of claim 13, further comprising a low voltage boost regulator operatively connected to the field effect transmitter for providing current to the field effect transmitter.

15. The visual indicator of claim 1, further comprising an actuator, and a connection to a monitoring system, wherein both the actuator and connection are operatively connected to the controller and configured to permit the controller to send a signal to a monitoring system when the actuator has been actuated.

16. A visual indicator comprising:
means for obtaining energy from sunlight;
means for storing energy operatively connected to the means for obtaining energy for charging the means for storing energy;
means for emitting light to the means for storing energy;
means for controlling the visual indicator operatively connected to the means for storing energy and the light emitting means to control operating characteristics of the means for storing light.

17. The visual indicator of claim 16, the means for controlling is configured to operate the means for emitting light to vary in at least one of the following operating characteristics: brightness, intensity, to flash, turn on, and turn off.

18. The visual indicator of claim 17, further comprising a means for sensing light operatively connected to the means for controlling to send a signal to the means for controlling associated to an amount of ambient light sensed by the means for sensing light.

19. A method of operating a visual sensor comprising:
recharging a battery from a solar panel;
emitting light with a light emitting diode (LED) from power provided by the battery;
sensing ambient light conditions proximate to the visual sensor;
varying an intensity of light emitted from the LED based on the sensed ambient light conditions.

20. The method of operating the visual sensor of claim 19 further comprising:
actuating an actuator associated with the visual sensor to at least one of: cause the LED emit light in a flashing manner and send a signal to a visual sensor monitoring system.

21. A visual indicator comprising:
a light emitting diode (LED) operatively connected to a power source to emit light;
a controller operatively connected to the power source and the LED to control operating characteristics of the LED, wherein the controller is configured to operate the LED to vary in at least one of the following operating characteristics: brightness, intensity, to flash, turn on, and turn off; and
a photo sensor operatively connected to the controller to send a signal to the controller associated to an amount of ambient light sensed by the sensor,
wherein the controller alters at least one operating characteristic of the LED in response to the signal received by the sensor.
